(19) United States
(12) Patent Application Publication
(10) Pub. No.: US 2019/0092374 A1
(43) Pub. Date: Mar. 28, 2019

(54) STEERING CONTROL ASSEMBLY FOR A VEHICLE STEER-BY-WIRE SYSTEM

(71) Applicant: Dura Operating, LLC, Auburn Hills, MI (US)

(72) Inventor: Aubrey J. Nofzinger, Rochester Hills, MI (US)

(21) Appl. No.: 15/719,117

(22) Filed: Sep. 28, 2017

(51) Int. Cl. B62D 5/00; B62D 5/04

(52) U.S. Cl. CPC B62D 5/005; B62D 5/0421

(57) ABSTRACT

In at least some implementations, a steering assembly includes a steering shaft rotatable in response to an input, an actuator having an output, a gear train and a housing. The gear train couples the steering shaft with the output so that the actuator can apply a force to the steering shaft via the output and gear train. The gear train provides a change in torque from the output to the steering shaft, such as to increase the torque provided from the actuator. The housing surrounds at least part of the gear train and includes gear teeth that define part of the gear train and are arranged to engage at least one other gear of the gear train.

### TECHNICAL FIELD

The present disclosure relates to a steering control assembly for a vehicle steer-by-wire system.

### BACKGROUND

Conventional vehicle steering systems require a mechanical linkage between a vehicle steering wheel and the road wheels. A force is needed to move the mechanical components and steer the vehicle. As the mechanical linkage is not required in steer-by-wire systems, there is a need to provide feedback to a driver that may be similar to the load on the steering system provided by the mechanical components in traditional steering systems.

### SUMMARY

In at least some implementations, a steering assembly includes a steering shaft rotatable in response to an input, an actuator having an output, a gear train and a housing. The gear train couples the steering shaft with the output so that the actuator can apply a force to the steering shaft via the output and gear train. The gear train provides a change in torque from the output to the steering shaft, such as to increase the torque provided from the actuator. The housing surrounds at least part of the gear train and includes gear teeth that define part of the gear train and are arranged to engage at least one other gear of the gear train.

In at least some implementations, the gear train includes a first planetary gear set having a first sun gear coupled to the output, a first planet carrier, and multiple first planet gears carried by the first planet carrier. Each first planet gear is meshed with the first sun gear and with the gear teeth of the housing, where the gear teeth formed in the housing define a ring gear located radially outwardly surrounding the first planet gears. In at least some implementations, the housing is not rotated as the first sun gear and first planet gears rotate. The first planet carrier may be coupled to the steering shaft for rotation with the steering shaft.

In at least some implementations, the gear train includes a second planetary gear set having a second sun gear coupled to the first planet carrier, a second planet carrier, and multiple second planet gears carried by the second planet carrier, each second planet gear being meshed with the second sun gear and with the gear teeth of the housing, wherein the gear teeth of the housing define a ring gear located radially outwardly surrounding the second planet gears. In such implementations, the second planet carrier may be coupled to the steering shaft for rotation with the steering shaft. In this way, the gear train may include a first gear set coupled to the output and a second gear set coupled to both the steering shaft and to the first gear set, where the second gear set is coupled to the first gear set either directly or via one or more intervening gears.

In at least some implementations, the actuator may include an electric motor and the output may be a drive shaft rotated by the motor, and the drive shaft may be coaxial with the steering shaft, and axially spaced from the steering shaft.

In at least some implementations, a steering assembly for a steer-by-wire steering system includes a first housing having an interior, a steering shaft having at least a portion within the interior of the first housing, a second housing coupled to the first housing and including inwardly extending gear teeth, at least one gear received within the second housing and having teeth meshed with the inwardly extending gear teeth of the second housing, and an actuator coupled to the second housing and having an output that drives said at least one gear for rotation relative to the second housing.

In at least some implementations, the second housing includes a main body and the inwardly extending teeth are formed directly in the main body. In at least some implementations, multiple gears are meshed with the inwardly extending gear teeth of the second housing. And the actuator may include a housing that is mounted to the second housing.

### BRIEF DESCRIPTION OF THE DRAWINGS

The following detailed description of representative implementations and best mode will be set forth with regard to the accompanying drawings, in which:

FIG. 1 illustrates a steer-by-wire system that includes a steering assembly, shown in perspective, and a schematic diagram of other portions of the system;

FIG. 2 is a cross-sectional view of a steering assembly for a steer-by-wire system;

FIG. 3 is an enlarged, perspective sectional view of a portion of the steering assembly;

FIG. 4 is an end view of a portion of a force transmission assembly of the steering assembly;

FIG. 5 is a side view of a gear train of the force transmission assembly;

FIG. 6 is a perspective view of a portion of the gear train;

FIG. 7 is a rear perspective view of a carrier of the gear train;

FIG. 8 is a front perspective view of the carrier;

FIG. 9 is an end view of a portion of the steering assembly showing a rotation limiter assembly;

FIG. 10 is a perspective view of a gear carrier of the rotation limiter assembly; and

FIG. 11 is a perspective view of a housing including a rotation limiting stop surface.

### DETAILED DESCRIPTION

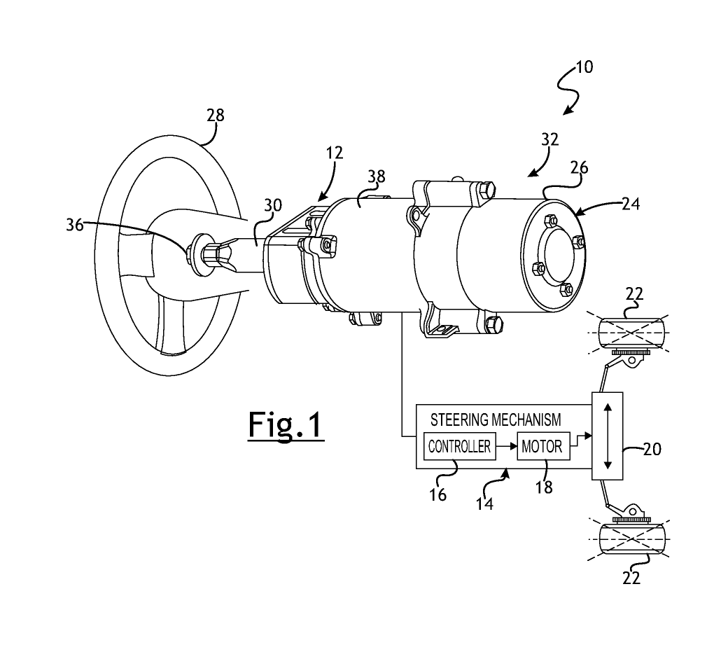

Referring in more detail to the drawings, FIG. 1 illustrates one embodiment of a vehicle steer-by-wire system 10 that includes a steering assembly 12 electrically coupled to a steering output mechanism 14 which may include a controller 16, an electric motor 18, and a gearing or transmission system 20 used to actuate or turn the wheels 22 of a vehicle. For example, the controller 16 may receive steering control signals from the steering assembly 12, control the electric motor 18 using those control signals, and the electric motor 18 then may actuate the gear system 20 to turn the wheels 22. For example, controlling the electric motor 18 to operate in a first direction (e.g., clockwise) may cause the gear assembly 20 to drive the wheels 22 rightward, while controlling the electric motor 18 to operate in an opposing direction (e.g., counter-clockwise) may cause the gear assembly 20 to drive the wheels 22 leftward. In at least some implementations, no mechanical linkage is required between the steering assembly 12 and the gearing system 20. Of course, the steering mechanism 14 shown in FIG. 1 is merely illustrative, and other implementations are possible.

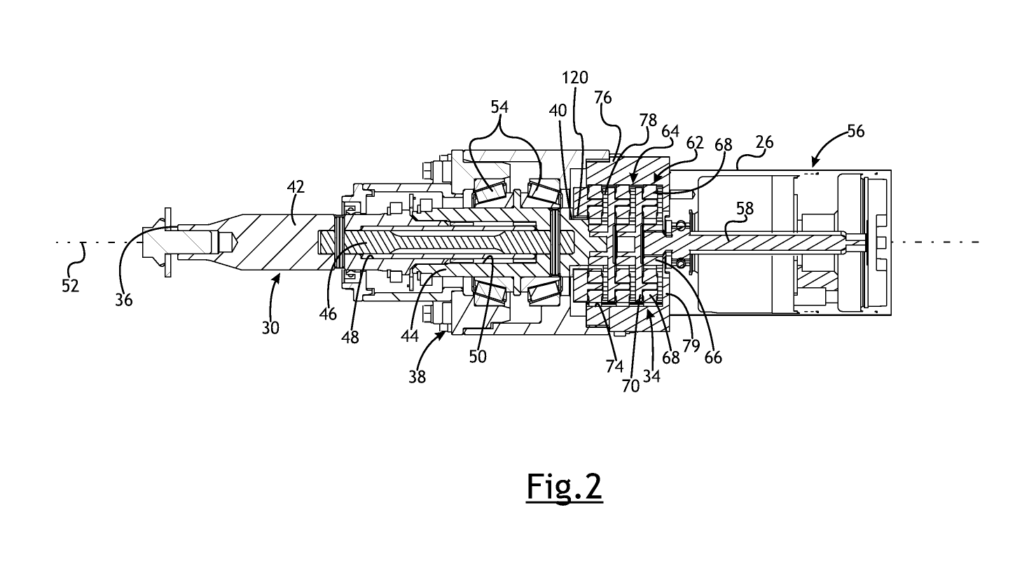

As will be explained in greater detail below, the steering assembly 12 includes a steering control assembly 24 which, in FIG. 2, is partially contained within an end cover or housing 26. The control assembly 24 is adapted to selectively change the force needed to rotate a steering wheel 28 or other steering input, as desired. This may provide some “road-feel” or other feedback to the driver to improve steering feel and control, which may be variable dependent upon a number of factors, for example, vehicle speed.

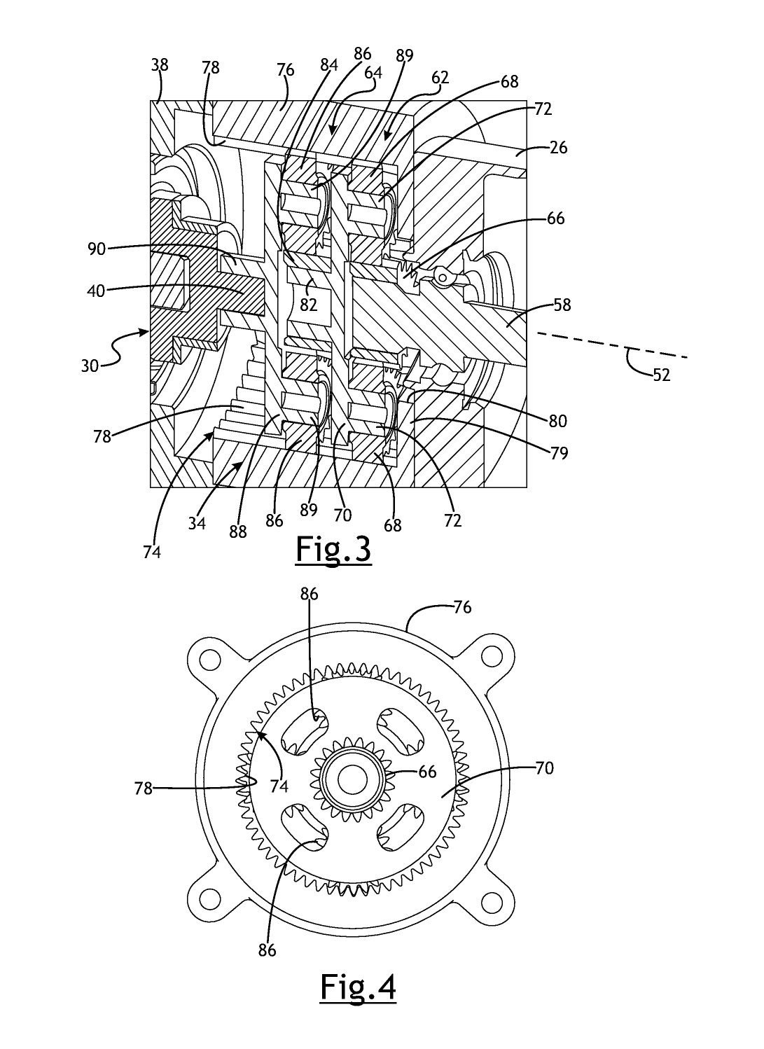

As shown in FIG. 3, the steering assembly 12 includes an input or steering shaft 30 coupled to the steering wheel 28 (FIG. 1, or other steering input) for rotation with the steering wheel, and the control assembly 24 is coupled to the steering shaft 30 via a transmission 34 to at least selectively provide a force to the steering shaft to either assist or resist rotation of the steering shaft. The steering shaft 30 has a first end 36 that extends outwardly from a first housing 38 of the steering assembly 12 and a second end 40 that may be received within the first housing 38 or which may extend outwardly therefrom. Hence, a mid-portion of the steering shaft 30 may be received and extend laterally or axially within an interior of the first housing 38. The steering wheel 28 may be coupled to the first end 36 of the steering shaft 30 outboard of the first housing 38 and the control assembly 24 may be coupled to the steering shaft 30, such as at the second end 40 of the steering shaft. The steering shaft 30 may be formed by multiple components and in the illustrated embodiment is shown as having a first portion 42 that defines the first end 36 of the steering shaft and which extends into the first housing 38 and is coupled to a second portion 44. A torsion bar 46 may be received in aligned and oppositely facing cavities 48, 50 of the first and second portions 42, 44 of the steering shaft 30, and the torsion bar may be coupled to both of the first and second portions in a known arrangement that permits some relative twisting or torsion between the first and second portions of the steering shaft. This may facilitate a determination of the relative torsional force applied to the steering shaft 30, if desired. Among other things, this may permit a determination of the desired rate of turning of the vehicle wheels 22 that is desired by the driver. The steering shaft 30 may be journaled for rotation about an axis 52 by one or more bearings 54 received within the interior of the first housing 38 or otherwise.

The control assembly 24 may include an actuator 56 that drives an output 58 (e.g. rotates the output) to provide a force to the steering shaft 30 to inhibit or assist rotation of the steering shaft. In at least some implementations, the control assembly 24 includes an electric motor 56 that has a drive shaft 58 (i.e. output shaft) that is coupled to the steering shaft 30 as set forth in more detail below. The electric motor 56 may be reversible to rotate the output shaft 58 in both directions about an axis 52 to provide a force to the steering shaft 30 when the motor 56 is actuated. The output shaft 58 may be coaxial with the steering shaft 30, axially spaced from the steering shaft and, as noted above, may be coupled to the steering shaft via a transmission 34. The actuator, e.g. motor, may include an outer casing or housing 26.

To facilitate use of a smaller and less powerful motor 56, which may weigh and cost less than a more powerful motor, the transmission 34 may include a gear train having multiple gears arranged to increase the torque provided by the motor 56 to the steering shaft 30. In at least some implementations, the gear train includes at least one planetary gear set and in the illustrated implementation, the gear train includes two planetary gear sets 62, 64 arranged in series to provide two stages of torque increase between the motor 56 and the steering shaft 30.

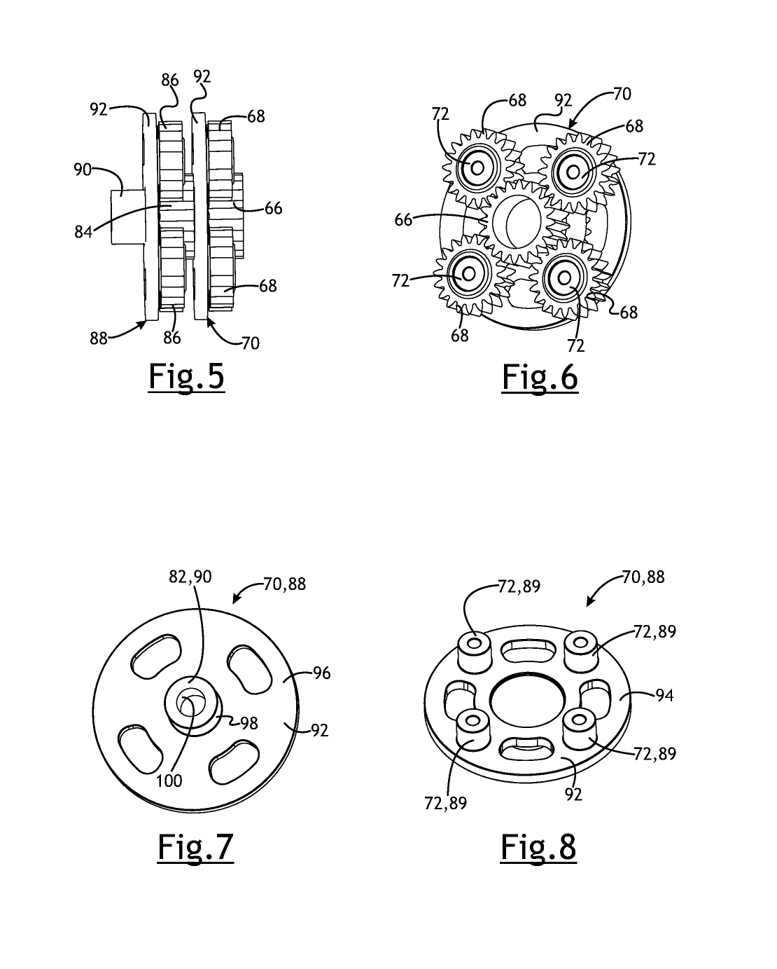

As shown in FIGS. 2-6, a first stage 62 of the gear train includes a sun gear 66 coaxially aligned with and coupled to or formed integrally as part of the motor output shaft 58. The sun gear 66 is meshed with and drives multiple planet gears 68 that are rotationally received on a carrier 70 for rotation about axes that are parallel to but radially offset from the axis 52 of the sun gear 66 and output shaft 58. To this end, the carrier 70 includes a hub or pin 72 for each of the planet gears 68, with each planet gear arranged for rotation relative to the carrier 70 about its pin 72.

The gear train also includes a ring gear 74 radially outwardly spaced from, surrounding and meshed with the planet gears 68. The ring gear 74 may be fixed against rotation so that the sun gear 66, planet gears 68 and planet carrier 70 rotate relative to the ring gear 74. In at least some implementations, the ring gear 74 is integrally formed in a portion of the first housing, and/or with a second housing 76 that is coupled to the first housing 38. As shown, the second housing 76 includes an inner surface and teeth 78 defining the ring gear 74, which may be formed in the inner surface of the second housing 76 so that the ring gear and corresponding portion of the housing 76 are formed in the same piece of material. This reduces the complexity and cost of having to secure a separate ring gear body to the housing, eliminates a tolerance that would be inherent in connection of a separate ring gear body to the housing and thus, reduces the tolerance stack-up within the gear train to increase the efficiency of the gear train and facilitate assembling the steering assembly. Of course, a ring gear may be formed separately from the housing(s) and coupled in any desired fashion (e.g. weld, adhesive, fastener, etc.) thereto, if desired. Providing the ring gear 74 integral with a second housing 76 that is coupled to the first housing 38 may facilitate use of different second housings 76 having a different ring gear arrangement that may be used with different planet gears (or with a different number of stages of gears—e.g. use of an axially shorter housing with fewer gear sets) without having to change the entire steering assembly housing. Further, the motor 56 may be coaxially coupled to the housing portion that defines the ring gear 74 (e.g. either the first or second housing) which as illustrated in the drawings, is the second housing 76. As shown in FIG. 3, the second housing 76 includes an end wall 79 to which the actuator housing 26 is coupled, and the end wall has an opening 80 into which the output shaft 58 extends.

In addition to the pins 72 for the planet gears 68, the planet carrier 70 of the first stage gear set 62 may include an oppositely facing coupler (e.g. a hub or pin 82) on which the sun gear 84 of the second stage gear set 64 is mounted. The second stage sun gear 84 may be fixed to the hub 82 (or integrally formed on or with the hub) of the first stage planet carrier 70 for co-rotation with the first stage planet carrier. The remainder of the second stage 64 may be the same as the first stage 62, including multiple second stage planet gears 86 meshed with the second stage sun gear 84, mounted to a second stage planet carrier 88 (on hubs or pins 89 fixed to the planet carrier) and meshed with the ring gear 74. The second stage planet carrier 88 may include a coupler 90 (e.g. a hub or pin) to which the steering shaft 30 is connected for co-rotation of the steering shaft and the second planet carrier. Hence, a torque path is defined between the steering shaft 30 and motor 56, through the second stage gear set 64 and the first stage gear set 62. Of course, only one gear stage may be used, or more than two gear stages may be used, as desired to achieve a desired torque in the steering assembly. Further, where a torsion bar 46 or some other component permits relative torsional rotation of portions of the steering shaft, it may be desirable in at least some implementations to provide the transmission 34 and motor 56 coupled to the steering shaft 30 on the opposite side of the torsion bar (or other torsion component) as the steering wheel 28.

As best shown in FIGS. 2, 3, 5, 7 and 8, the planet carriers 70, 88 for both the first and second stages 62, 64 may be the same (e.g. the same size and shape and formed with the same features). Each planet carrier 70, 88 may include a main body 92 having a first face 94 oriented facing the motor 56 and a second face 96 oriented facing the steering shaft 30. Extending from the first face 94, the main body 92 of each planet carrier 70, 88 may include a separate hub or pin 72, 89 for each of the planet gears 68, 86 mounted to the planet carriers. Extending from the oppositely oriented second face 96, each planet carrier 70, 88 may include a coupler 82, 90 for a sun gear of a different stage gear set or for coupling to the steering shaft 30. The couplers 82, 90 may be coaxially arranged with the steering shaft 30 and motor output shaft 58, as well as the sun gears 66, 84 within the gear train. In the example shown, the couplers 82, 90 are annular and tubular, and have an outer surface 98 to which a sun gear 84 may be mounted and an inner surface 100 to which the steering shaft 30 may be connected. Of course, the sun gear 84 could include a post received within the hub 82 and the steering shaft 30 could be received over the outer surface 100 of the hub 90, if desired.

Hence, the motor 56 is mechanically coupled to the steering shaft 30 and may be actuated to provide so-called ‘road-feel’ to the driver—e.g., a rotational resistance profile experienced by the driver which typically is associated with turning a steering wheel mechanically coupled to the vehicle wheels (e.g., in a non-steer-by-wire system). Thus, by selectively actuating the motor 56, the motor may provide rotational resistance to the steering shaft 30 and connected steering wheel 28 to simulate road-feel to the driver.

Further, the actuator output shaft 58 and the steering shaft 30 may each have ends that are radially overlapped by the housing 76 in which the ring gear teeth 78 are formed. In the illustrated embodiment, the second housing 76 overlaps ends of the steering and output shafts 30, 58, as well as the gears of the transmission 34. The gear train 34, steering shaft 30, output shaft 58 and motor 56 may all be coaxially aligned which may facilitate a balanced torque transmission between these components.

In at least some implementations, the extent to which the steering shaft 30 may be rotated may be limited by one or more end stops, which may, for example, be arranged so that the steering shaft and steering wheel 28 may rotate more than one full revolution in each direction from a centered position. In at least some implementations, the steering wheel 28 may rotate a total of 3.5 revolutions from engagement with an end stop in one direction to engagement with an end stop in the other direction of steering wheel rotation. To reduce the abruptness of the engagement of a portion of the steering assembly 12 with the end stop(s), the motor 56 may be actuated to provide a counterforce (i.e. a force in the opposite direction from the steering force) before the end stop will be encountered. To accomplish this, the steering position sensors may provide a signal to a controller 16 that controls actuation of the motor 56 when the steering wheel 28 has met or exceeded a threshold amount of rotation in either direction. For this purpose and/or for the purpose of providing road feel or other force profile to the steering shaft 30, the transmission 34 may provide a torque increase of 1.5:1 to 30:1 from the motor 56 to the steering shaft 30. In one non-limiting example, each of the planetary gear stages 62, 64 provides a 4:1 torque increase so both gear stages provide a torque increase of 16:1 from the output shaft 58 to the steering shaft 30. Of course, other torque values may be used as desired.

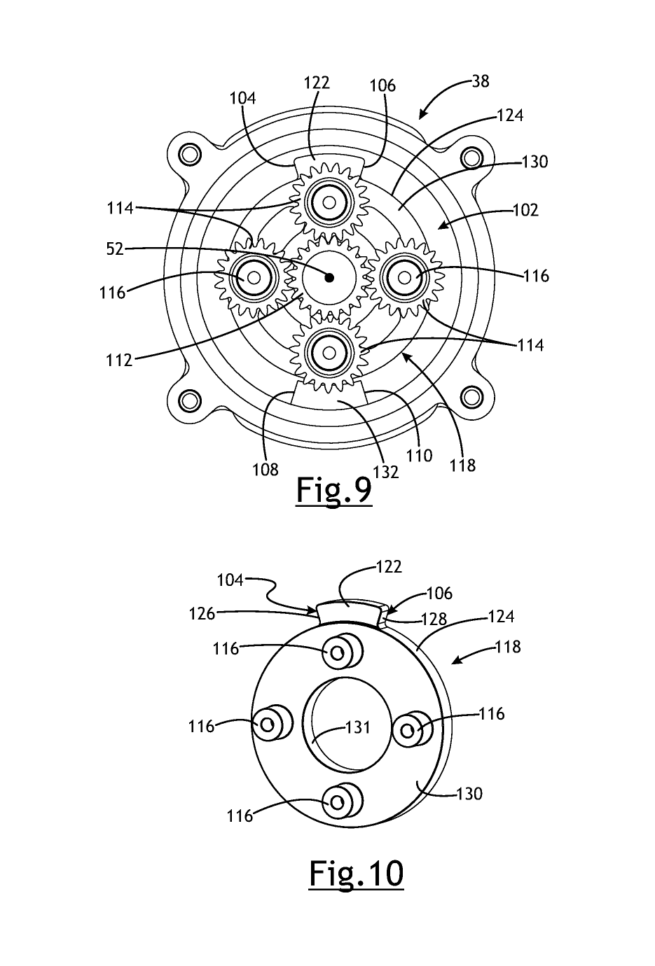

As shown in FIGS. 9-11 (and to some extent in FIG. 2), engagement of end stops to limit the rotation of the steering shaft 30 may be accomplished with a rotation limiting gear set 102 coupled to the steering shaft 30. The rotation limiting gear set 102 may include one or more movable stop surfaces 104, 106 that are engageable with fixed stop surfaces 108, 110 to limit rotation of the steering shaft 30. In at least some implementations, the rotation limiting gear set 102 is a speed reducing gear set that has an output that rotates fewer times than does the steering shaft 30 (which is the input to or is coupled to the input of the gear set). Any desired type of rotation or speed reducing gear set may be used.

In the example shown, the rotation limiting gear set 102 includes a planetary gear set having a third sun gear 112 that is fixed relative to the steering shaft 30 so that the third sun gear and steering shaft rotate together. As shown, the third sun gear 112 is fixed to the second end 40 of the steering shaft 32 and is hence, on the opposite side of the torsion bar 46 as the steering wheel 28. Also as shown, the third sun gear 112 and the steering shaft 30 are fixed to the hub 90 of the second planet carrier 88 so that the second planet carrier, third sun gear and steering shaft rotate together and are coaxial. This also places the rotation limiting gear set 102 in parallel with the second gear set 64 and not in series with it. The result is that the rotation limiting gear set 102 is not within the torque flow path between the motor 56 and steering shaft 30 and the rotation limiting gear set does not increase the torque that the motor provides to the steering shaft.

In the planetary gear set, the third sun gear 112 is meshed with multiple third planet gears 114 that are carried on pins 116 of a third planet carrier 118. The third planet gears 114 are each meshed with a ring gear 74 that is fixed against rotation (that is, it does not rotate due to rotation of the planet gears). The ring gear 74 may be separate from or the same ring gear(s) of the first and second gear sets 62, 64 (e.g. in the embodiment shown, the third planet gears may engage the same inwardly extending teeth 78 of the second housing 76). In this way, the teeth 78 of the second housing 76 may extend along an axial length sufficient to engage all three gear sets 62, 64, 102, or the teeth may be provided in discrete sections that are aligned with the planet gears of each gear set, with gaps or spaces between the discrete sets of teeth. Accordingly, as the steering shaft 30 rotates, the third sun gear 112 rotates and drives the third planet gears 114 for rotation relative to the ring gear 74, which causes rotation of the third planet carrier 118 relative to the steering shaft 30 at a reduced rotational rate that corresponds to the gear ratio of the rotation limiting gear set 102. To support and journal for rotation the third planet carrier 118, a bearing 120 (FIG. 2) may be provided between the steering shaft 30 and the third planet carrier, if desired. While a planetary gear set may provide a coaxial arrangement of the gears 74, 112, 114, 118 with the steering shaft 30 (and perhaps a balanced weight distribution and coaxial packaging), other gears may be used, as desired.

In at least some implementations, the movable stop surfaces 104, 106 are carried by the planet carrier 118 and each is engageable with a respective one of the fixed stop surfaces 108, 110 to define the end points of steering shaft rotation in each direction of rotation (i.e. one end point in each direction of rotation). In the example shown in FIGS. 9 and 10, the planet carrier 118 includes a tab 122 that extends outwardly from a radially peripheral side or edge 124 of the planet carrier. The tab 122 has side edges that each define one of the stop surfaces 104, 106. A first side edge 126 defining the first movable stop surface 104 is engageable with the first fixed stop surface 108 and a second side edge 128 defining the second movable stop surface 106 is engageable with the second fixed stop surface 110. The third planet carrier 118 has a main body 130 that is arranged perpendicular to the rotational axis 52 of the planet carrier and sun gear 112 and from which the pins 116 extend generally perpendicularly (e.g. parallel to the axis). A central opening 131 may be provided and the bearing 120 and part of the steering shaft may be received in the opening 131. The third planet carrier 118, in this implementation, does not mount a sun gear and is not coupled to the steering shaft 30, so no hub (like hubs 82, 90) is needed. The tab 122 or movable stop surfaces 104, 106 may extend radially from the main body 130 as shown (and may have an axial thickness commensurate with the thickness of the main body so that the tab does not extend axially from the main body) or the tab may extend axially from the main body (e.g. not radially outboard of the nominal periphery of the main body). Of course, the tab(s) 122 could extend both radially and axially, or in any desired direction so that the movable stop surfaces 104, 106 overlap and are engageable with the fixed stop surfaces 108, 110 to limit rotation of the planet carrier, and hence, the steering shaft 30.

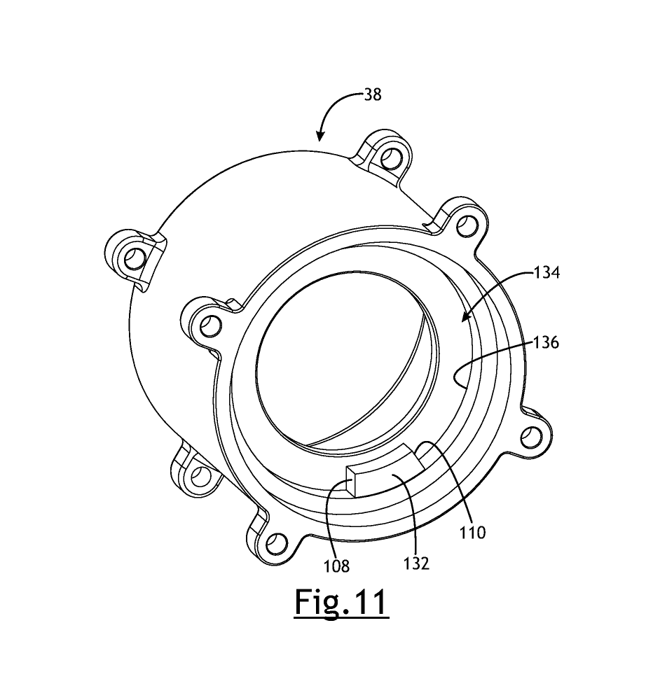

In the example shown in FIGS. 9 and 11, the fixed stop surfaces 108, 110 are defined in or by the housing of the steering assembly 12, and more particularly, in a projection 132 formed in or fixed to the first housing 38. The fixed stop surfaces 108, 110 are overlapped (radially and axially in the illustrated example) with the movable stop surfaces 104, 106, in other words, the fixed stop surfaces are within the path of rotation of the movable stop surfaces. In the example shown, the housing 38 includes a cavity 134 defined at least in part by an inner surface 136, and the rotation limiting gear set 102 is arranged at least partially in the cavity. The projection 132 and its fixed stop surfaces 108, 110 extend radially inwardly from the inner surface 136 so that the fixed stop surfaces are within the path of rotation of the movable stop surfaces 104, 106 (i.e. the tab 122). Therefore, rotation of the planet carrier 118 in one direction brings the first movable stop surface 104 into engagement with the first fixed stop surface 108 and rotation of the planet carrier in the opposite direction brings the second movable stop surface 106 into engagement with the second fixed stop surface 110. While the movable stop surfaces 104, 106 are shown as being formed or defined by the same tab 122 of the planet carrier 118, the movable stop surfaces could be spaced apart and defined by separate features that are integrally formed in the same piece of material as the planet carrier or as separate bodies fixed to the planet carrier. Likewise, the fixed stop surfaces 108, 110 may be formed in one projection or multiple projections, and the projections may be defined by separate features that are integrally formed in the same piece of material as the housing or as separate bodies fixed to the housing.

In the position of the planet carrier 118 shown in FIG. 9, the steering shaft 30 is centered, that is, the steering shaft is generally at a midpoint of its permitted rotation and may rotate generally equally in either direction until engagement of a moveable stop 104, 106 with a fixed stop surface 108, 110. Because there is some circumferential distance between the first and second moveable stop surfaces 104, 106 (i.e. the side edges 126, 128) and also some distance between the fixed stop surfaces 108, 110, the planet carrier 118 can rotate less than 180 degrees in each direction from the centered position. In at least some implementations, the planet carrier 118 may rotate between 90 and 178 degrees in either direction from the centered position until a moveable stop surface 104, 106 engages a fixed stop surface 108, 110. One consideration may be the strength of the stop surfaces (e.g. the strength of the tab(s) 122 or projection(s) 132), where thinner pieces of material may be weaker than desired to counteract the forces provided on the steering shaft 30 through the steering wheel 28. Accordingly, the tab(s) 122 and projection(s) 132 may be designed to withstand a desired force of engagement, and the gears 112, 114 may be chosen to provide a desired gear ratio and a maximum rotation of the steering wheel 28.

In at least some implementations, the rotation limiting gear set 102 provides a gear ratio of between 1.5:1 and 8:1. In the example shown, the gear ratio of the rotation limiting gear set is 4:1, and the steering shaft 30 may rotate more than once in each direction from the centered position before the stop surfaces are engaged. In at least some implementations, the steering wheel 28 may rotate a total of more than three revolutions between its opposed rotational end points while the planet carrier 118 rotates less than one revolution (i.e. less than 360 degrees). In one non-limiting example, the steering wheel rotates 3.5 revolutions, from one end point to the other end point, or 1.75 revolutions from the center position to each end point, and the planet carrier rotates less than 180 degrees from the center position to each end point.

The mechanical stops (e.g. stop surfaces 104-110) operate even when electric power is not available which is not the case with electrically powered brakes or clutches that may be used in steering systems. Further, the mechanical stops are light weight, of simple design and durable, whereas electrically actuated brakes or clutches may be heavier, more complex and less reliable over time. Further, the steering wheel rotational limits are easy to control by placement of the opposed stops 104-110 and by choosing a gear ratio for the rotation limiting gear set 102.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A steering assembly, comprising:
a steering shaft rotatable in response to an input;
an actuator having an output;
a gear train coupling the steering shaft with the output so that the actuator can apply a force to the steering shaft via the output and gear train, the gear train providing a change in torque from the output to the steering shaft; and
a housing surrounding at least part of the gear train and including gear teeth that define part of the gear train and are arranged to engage at least one other gear of the gear train.

2. The assembly of claim 1 wherein the gear train includes a first planetary gear set having a first sun gear coupled to the output, a first planet carrier, and multiple first planet gears carried by the first planet carrier, each first planet gear being meshed with the first sun gear and with the gear teeth of the housing, wherein the gear teeth of the housing define a ring gear located radially outwardly surrounding the first planet gears.

3. The assembly of claim 2 wherein the housing is not rotated as the first sun gear and first planet gears rotate.

4. The assembly of claim 1 wherein the actuator includes an electric motor and the output is a drive shaft rotated by the motor, and wherein the drive shaft is coaxial with the steering shaft.

5. The assembly of claim 4 wherein the drive shaft is axially spaced from the steering shaft.

6. The assembly of claim 2 wherein the first planet carrier is coupled to the steering shaft for rotation with the steering shaft.

7. The assembly of claim 2 wherein the gear train includes a second planetary gear set having a second sun gear coupled to the first planet carrier, a second planet carrier, and multiple second planet gears carried by the second planet carrier, each second planet gear being meshed with the second sun gear and with the gear teeth of the housing, wherein the gear teeth of the housing define a ring gear located radially outwardly surrounding the second planet gears.

8. The assembly of claim 7 wherein the second planet carrier is coupled to the steering shaft for rotation with the steering shaft

9. The assembly of claim 1 wherein the gear train includes a first gear set coupled to the output and a second gear set coupled to both the steering shaft and to the first gear set, where the second gear set is coupled to the first gear set either directly or via one or more intervening gears.

10. The assembly of claim 7 wherein the first and second sun gears are constructed the same, the first and second planet carriers are constructed the same and the first and second planet gears are constructed the same.

11. The assembly of claim 1 wherein the first sun gear is fixed to the output so that these components rotate together.

12. The assembly of claim 1 wherein the housing includes a first opening into which an end of the steering shaft extends and a second opening into which the output extends.

13. The assembly of claim 1 wherein the actuator includes a casing and the casing is fixed to the housing.

14. The assembly of claim 2 wherein the first planetary gear set provides an increase of torque provided by the output of between 1.5:1 and 30:1.

15. The assembly of claim 7 wherein the first and second planetary gear sets each provide an increase of torque of between 1.5:1 and 30:1.

16. A steering assembly for a steer-by-wire steering system, comprising:
a first housing having an interior;
a steering shaft having at least a portion within the interior of the first housing;
a second housing coupled to the first housing and including inwardly extending gear teeth;
at least one gear received within the second housing and having teeth meshed with the inwardly extending gear teeth of the second housing; and
an actuator coupled to the second housing and having an output that drives said at least one gear for rotation relative to the second housing.

17. The assembly of claim 16 wherein the housing includes a main body and the inwardly extending teeth are formed directly in the main body.

18. The assembly of claim 16 wherein said at least one gear includes multiple gears that are meshed with the inwardly extending gear teeth of the second housing.

19. The assembly of claim 16 wherein the actuator includes a housing that is mounted to the second housing.
